(19) United States
(12) Patent Application Publication
(10) Pub. No.: US 2006/0253362 A1
(43) Pub. Date: Nov. 9, 2006

(54) Computer-based control of a flow of funds

(76) Inventor: Andreas Kipp, Stuttgart (DE)

Correspondence Address: WILLIAM COLLARD;COLLARD & ROE, P.C., 1077 NORTHERN BOULEVARD, ROSLYN, NY, 11576, US

(21) Appl. No.: 11/414,715

(22) Filed: Apr. 28, 2006

(30) Foreign Application Priority Data
Apr. 28, 2005 (DE) 10 2005 020 214.4

(51) Int. Cl. G06Q 40/00

(52) U.S. Cl. 705/35

(57) ABSTRACT

Funds are used on the basis of carefully made forecasts and continue to be used unchanged for a respective prescribed period of time which is shortened only if a prescribed opportunity for realizing a profit arises.

### CROSS REFERENCE TO RELATED APPLICATIONS

Applicant claims priority under 35 U.S.C. §119 of German Application No. 102005 020 214.4 filed Apr. 28, 2005

The invention relates to computer-based control of a flow of funds with iterative forecasting for a multiplicity of investment opportunities.

It is well known practice to use computers for managing financial deposits and associated flows of funds, with financial commitments being entered into when forecasts predict sufficient opportunities for profit in the respective commitments. Conversely, financial commitments are canceled if forecasts indicate diminishing opportunities for profit or even the possibilities of losses.

In addition, computers are also used for making the forecasts, in order to be able to take into account and/or capture a large volume of data.

It is an object of the invention to use forecasting options particularly effectively for financial commitments and to enter into these commitments with a high likelihood of success.

This object is achieved in that

(A) a long-term, averaged forecast for a change in value or price in respect of different investment opportunities is regularly made at relatively long first time intervals, e.g. quarterly or annually or every few years,

(B) a current actual value for a significant variable, such as value or price, in respect of the investment opportunities is regularly recorded at second time intervals, which are short in comparison with the longer first time intervals, e.g. every working day or weekly or monthly, and the long-term, averaged forecast and also a prescribed number of the respective most recent actual values for this significant variable are taken into account to ascertain a current change which is to be expected, for example price potential, by which the current actual value will rise or fall within an immediately subsequent third time period, the extent of which is in a mid-range between the longer first time interval and the shorter second time interval,

(C) funds distributed for a plurality of investment opportunities for which the current change which is to be expected exceeds prescribed threshold values in the direction of the change which is to be expected are scheduled and remain scheduled for no longer than the aforementioned third time period.

The invention is based, in particular, on the idea of carefully checking the potential for profit before entering into financial commitments, but then maintaining the respective commitment made for a certain time period, specifically, in principle, regardless of changes which arise in the significant variable after the commitment has been made.

This prevents commitments which have been entered into from being able to be checked and canceled, usually at considerable cost, after just a very short time.

In line with one preferred procedure, schedules made are respectively canceled or implemented at the end of the aforementioned third time period or beforehand, if said threshold value is reached beforehand.

The background to this procedure is that the respective investment is successful upon reaching the threshold value and the realizable profit then also needs to be realized in line with the invention. On the other hand, even if this threshold value should not be reached, it can be assumed with a high degree of probability that within the third time period the threshold value will more or less be reached, and accordingly the investment target will be reached at least in part, so that realization is likewise indicated. Furthermore, losses, which are not very likely per se, are amortized no later than at the end of the third time period. This means that losses cannot be “dragged onward”.

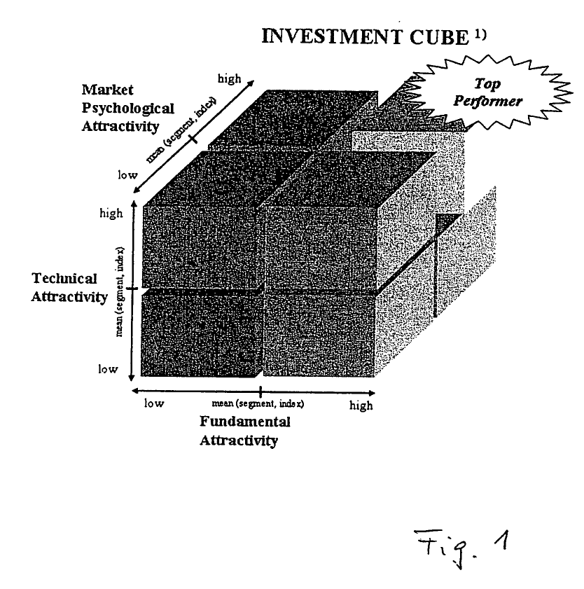

The careful checking of financial commitments with a potential for profit as a result of rising prices is effected as shown in FIG. 1, which shows an “investment cube”, which is also part of the invention and can be used for the global capital/investment/financial markets and their segments (e.g. shares, bonds, raw materials, foreign currencies) and also part-segments and subsegments. This gives rise to the preferred investment strategy within the context of the invention.

On the basis of FIG. 1, top performers are sought, i.e. investment opportunities whose prices tend to rise for short-term/medium-term/long-term investment periods. Top performers are investment opportunities with excellent fundamental, technical and market-psychological parameters which are situated clearly above the average for the appropriate segment or index within a prescribable rating system. The most important capital market segments are shares, bonds, raw materials and foreign currencies.

The funds are distributed (within a capital market segment or across segments) and hence a portfolio is built up by selecting single assets (top performers in the investment cube) from different sectors and part-sectors which have a high probability of rising in the third time period. The diversification is made such that regardless of actual or expected (fundamental) economic activity data it is possible to realize profits continuously in the third time period, even if individual assets sometimes fall in price.

In addition, provision is preferably made for funds which are to be used to be distributed across segments or within segments (e.g. capital market segments: shares, bonds, raw materials, bonds) over various investment opportunities with rising and falling prices, i.e. over investment opportunities which complement one another, i.e. exhibit opposite tendencies to the change which is to be expected.

It is well known that profitable financial schedules can be made both for rising and falling prices, naturally provided that the falling and rising price tendencies have been predicted correctly. By virtue of the funds which are to be used now being scheduled both for investment opportunities which are profitable with rising prices and for investment opportunities which are profitable with falling prices, there is a comparatively high level of certainty, at least on average, of a profit being made according to probability. This is because it is extremely unlikely that both the predicted price increases and the predicted price decreases will simultaneously fail to arise, i.e. that presumed price increases will become price decreases and presumed price decreases will become price increases simultaneously. This is because forms of investment which complement one another do not usually change their respective development trend at the same time.

The ratio of the distribution of the funds over complementary investment opportunities is preferably determined on the basis of long-term and, in particular, fundamental economic activity data which are to be expected.

This takes account of the fact that in the case of a rise in economic activity which is to be expected over a longer period there are more investment opportunities in the area of rising prices and in the case of falling economic activity which is to be expected over a longer period there is a comparatively large number of investment opportunities in connection with falling prices.

In line with one very particularly preferred embodiment of the invention, all profits realized for schedules are scheduled in the long term for very safe forms of investment.

This ensures that profits made are maintained in all cases and cannot increase the overall risk for the investments made.

In addition, provision may expediently be made for new schedules to be made only when there is a minimum volume of funds. This means that it is always possible to ensure that the funds can be used within the context of the spreading of risk. Since schedules made in line with the invention cannot be revoked for a certain period of time, as set out above, there is a very high likelihood of there being a sufficient budget available for schedules again after this time period has elapsed.

The method based on the invention therefore requires no continually added new funds, even though it is an advantage. Furthermore, the available funds are certain to be continually relayered in optimizing fashion so as to optimize the prospects for a profit, specifically without revoking commitments which have been made within an inadmissibly short period.

The use of computers for the method steps based on the invention ensures with a high level of certainty that the desired investment strategy is actually implemented.

Overall, it can be stated that:

Funds are used on the basis of carefully made forecasts and continue to be used unchanged for a respective prescribed period of time which is shortened only if a prescribed opportunity for realizing a profit arises. Profits made are provided for very safe investments and are therefore sure to be obtained.

1. Computer-based control of a flow of funds with iterative forecasting for a multiplicity of investment opportunities, where
(A) a long-term, averaged forecast for a change in value or price in respect of various investment opportunities is regularly made at relatively long first time intervals, e.g. quarterly or annually or every few years.
(B) a current actual value for a significant variable, such as value or price, in respect of the investment opportunities is regularly recorded at second time intervals, which are short in comparison with the longer first time intervals, e.g. every working day or weekly or monthly, and the long-term forecast and also a prescribed number of the respective most recent actual values for this significant variable are taken into account to ascertain a current change which is to be expected, for example price potential, by which the current actual value will rise or fall within an immediately subsequent third time period, the extent of which is in a mid-range between the longer first time period and the shorter second time period, and
(C) funds distributed for a plurality of investment opportunities for which the current change which is to be expected exceeds prescribed threshold values in the direction of the change which is to be expected are scheduled or remain scheduled for the third time period.

2. Computer-based control according to claim 1, where schedules made are canceled or implemented at the end of the aforementioned third time period or beforehand when the threshold value is reached.

3. Computer-based control according to claim 1, where the long-term forecast is adapted continuously or at relatively short time intervals, with the respective adapted forecast being used for ascertaining the change which is to be expected.

4. Computer-based control according to claim 1, where funds which are to be used are distributed over various investment means which have opposite tendencies from one another to the changes which are to be expected.

5. Computer-based control according to claim 4, where the ratio for the distribution of the funds over the investment opportunities with opposite tendencies from one another to the changes which are to be expected is dependent on long-term and, in particular, fundamental economic activity data which are to be expected.

6. Computer-based control according to claim 1, where all profits realized for schedules are provided in the long term for very safe forms of investment.

7. Computer-based control according to claim 1, where the current change which is to be expected is ascertained using a multiplicity of parameters, particularly including market-psychology parameters, with a prescribable weighting.

8. Computer-based control according to claim 1, where investment opportunities are selected which have high fundamental, technical and psychological attractivities.
